(19) United States
(12) Patent Application Publication
(10) Pub. No.: US 2002/0005016 A1
(43) Pub. Date: Jan. 17, 2002

(54) Actuating system for motor-vehicle door latch

(75) Inventor: Johannes-Theodor Menke, Velbert (DE)

Correspondence Address: THE FIRM OF KARL F ROSS, 5676 RIVERDALE AVENUE, PO BOX 900, RIVERDALE (BRONX), NY, 10471-0900, US

(73) Assignee: Kiekert AG

(21) Appl. No.: 09/894,808

(22) Filed: Jun. 28, 2001

(30) Foreign Application Priority Data
Jun. 29, 2000 (DE) 10031664.6

(51) Int. Cl. E05F 15/00

(52) U.S. Cl. 49/503; 49/280

(57) ABSTRACT

A motor vehicle has a door latch having in turn an electrical operator and is displaceable thereby between a latched position holding a respective door shut and an unlatched position permitting the door to open freely. An actuating system has a deformable actuating body incorporating electrical conductors and constructed to radically change resistance between the conductors when deformed and a control circuit connected to the conductors and to the electrical latch operator for actuating the operator and displacing the latch in the open position on deformation of the body. The body is elongated and formed with a longitudinally extending cavity. In addition it is of an elastically deformable plastic and the conductors are imbedded in and extend longitudinally of the body. The conductors are parallel and spaced.

### FIELD OF THE INVENTION

The present invention relates to a motor-vehicle latch system. More particularly this invention concerns an actuating system for a motor-vehicle door latch.

### BACKGROUND OF THE INVENTION

A standard motor-vehicle door latch comprises a locking element such as a fork normally pivoted on a door edge and engageable in a latched position around a bolt fixed to the respective door post. A pawl is typically retracted out of engagement with the fork to allow it to move between the latched position in which it captures and retains the bolt to hold the door closed and an unlatched position in which the bolt and fork can move apart and the door can open. This pawl in turn is typically operated by a manual release mechanism coupled via a normally mechanical linkage to an inside or outside door handle, and by a remotely trippable operator typically formed as a small electric motor and transmission. In a standard central-lock system a controller connected to all of the operators of the latches can displace the latches between a locked position in which actuation of the respective handles is ineffective, and an unlocked position allowing the handles and the remote operator to unlatch the door.

German patent 197 55 843 of R. Hugel describes a device for remote actuation of an electrically operated motor-vehicle door latch. It has a bladder-type body that can be compressed to raise its internal pressure and actuate a pressure-sensitive switch connected to it. Such an actuator is fairly complex and, hence, expensive to manufacture and is subject to failure, for instance if it develops a leak. It has proven unusable in practice.

German patent 198 05 659 of P. Hauler proposes a system incorporating magnets and reed switches for triggering emission of a signal for verifying authorization to open the vehicle. This complex switch arrangement is provided on the inner face of the door handle to protect it from the elements, accidental actuation, and vandalism. It is once again quite complex, expensive, and failure prone.

The system of U.S. Pat. No. 6,098,432 of W. Spies describes a handle which operates a latch connected to it only in a predetermined position of an associated key-type lock cylinder. This cylinder operates a microswitch which controls operation of the latch. Such an arrangement is fairly difficult to adapt to operating a motor-vehicle door latch.

In German patent document 199 22 657 of W. Spies proposes using a simple switch to operate a system that assists the opening movement of a motor-vehicle door. A manual actuator is used that if necessary coacts with the microswitch which in turn triggers the drive for the door opener.

Finally German utility model 84 32 429 published Apr. 4, 1985 describes a push switch that can project through a door to be operated from both sides. This switch is not really suitable for use in a motor-vehicle door. It relies on quite a few mechanical parts that could not be counted on to have the long service life needed in a motor vehicle.

In general the known systems are too complex and/or too expensive for use in a motor-vehicle door to actuate a latch. In addition the known devices often require that the user be familiar with their operation in order to operate them properly so that the uninitiated cannot use them at all.

### OBJECTS OF THE INVENTION

It is therefore an object of the present invention to provide an improved actuating system for a motor-vehicle door latch.

Another object is the provision of such an improved actuating system for a motor-vehicle door latch which overcomes the above-given disadvantages, that is which is of simple but extremely durable construction, and that can be used even by someone not aware of the system and how it is supposed to operate.

### SUMMARY OF THE INVENTION

The instant invention is an actuator used in a motor vehicle having a door latch having in turn an electrical operator and displaceable thereby between a latched position holding a respective door shut and an unlatched position permitting the door to open freely. The actuating system has according to the invention a deformable actuating body incorporating electrical conductors and constructed to radically change resistance between the conductors when deformed and a control circuit connected to the conductors and to the electrical latch operator for actuating the operator and displacing the latch in the open position on deformation of the body.

Such resistance-changing actuating bodies are well known in the art, see for example U.S. Pat. Nos. 4,143,367, 5,549,962, or 6,233,872, and can be counted on to perform perfectly for a long time.

According to the invention the body is tubular, elongated, and formed with a longitudinally extending cavity. In addition it is of an elastically deformable plastic and the conductors are imbedded in and extend longitudinally of the body which can be extruded around the wires or coextruded therewith. The conductors are parallel and spaced. They can be formed as conductive or semiconductive wires, foil strips, tracks of conductive fibers, or the like that can be positioned to actually contact each other when the body is compressed. A piezoelectric effect can also be used by providing materials that change resistance when compressed, as in a strain gauge.

The control circuit according to the invention includes a resistance-measuring circuit connected across the conductors, for instance a bridge circuit. In addition the vehicle is formed with a panel having an outwardly directed outer face, an inwardly directed inner face and an edge between the faces, and a pocket at the edge. The body is at the edge on the inner face. Thus when the user does the natural movement to open the door, that is grasp its edge with the fingers behind the door edge where they will naturally engage the actuating body, the system will be effective to trip the electrical latch and allow the door to open. Even a person completely unfamiliar with the door can therefore open it.

In accordance with the invention the latch is displaceable between a locked condition in which the operator is ineffective and an unlocked condition in which the operator is effective. Means is furthermore provided for displacing the latch into the unlocked position so the body can actuate the operator. Thus the user will use the normal means—keyless remote, coded card, or simple key—to unlock the door, then will grasp the door edge and pull to open the door, the act of grasping the door edge automatically tripping the respective latch's operator to unlatch the already unlocked door.

### BRIEF DESCRIPTION OF THE DRAWING

The above and other objects, features, and advantages will become more readily apparent from the following description, reference being made to the accompanying drawing in which:

FIG. 1 is a sectional view illustrating the door actuator of the system of this invention;

FIGS. 1A and 1B are large-scale sections illustrating the door actuator in the unactuated and actuated positions; and

FIG. 2 is a schematic diagram of the system of this invention.

### SPECIFIC DESCRIPTION

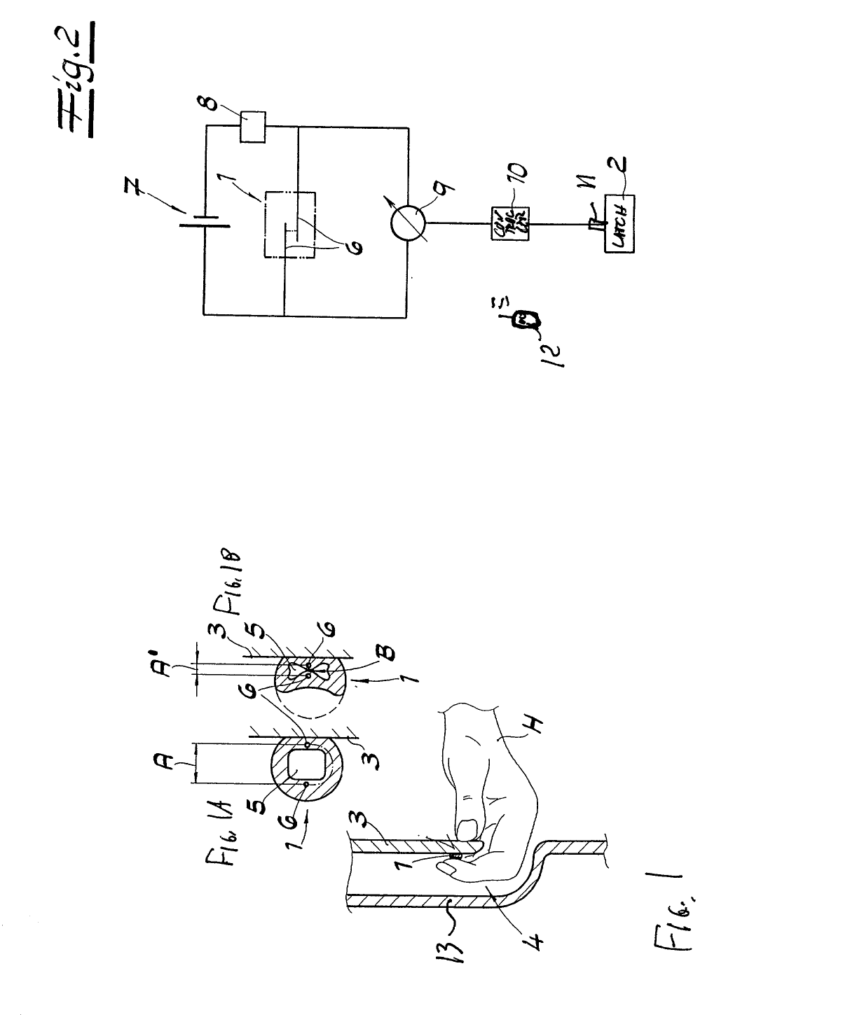

As seen in FIG. 1 a motor-vehicle body has a panel 3, typically formed at the edge of a door, which is provided on its inner face with an actuator 1 according to the invention, in a pocket 4 formed in the vehicle body 13 behind the panel 3 which is typically part of the vehicle door. Thus it is possible for a user's hand H to reach around and squeeze this actuator 1 in a natural movement prior to pulling the door incorporating the panel 3 open.

More specifically as shown in FIGS. 1A and 1B the actuator 1 is formed as an elastic plastic tube having a central cavity or passage 5 provided on diametrally opposite sides with conductors 6, here parallel longitudinally extending wires. As the tubular actuator 1 is compressed, a spacing A between the wires 6 is decreased to A′ and there is a corresponding radical change in the resistance between these conductors 6, normally a sharp decrease of the impedance between them. The actuator 1 can also be constructed as shown in U.S. Pat. Nos. 4,143,367, 5,549,962, or 6,233,872.

FIG. 2 shows how two conductors 6 of the actuator 1 are connected in series with a load resistor 8 across a power source 7, here a motor-vehicle battery. A resistance-evaluating circuit of a controller 10 is connected to an operator 11 (see U.S. Pat. No. 5,149,156) of a latch 2. A remote 12 can operate the latch 2 via the controller 10 to displace the latch 2 between a latched position holding the door with the panel 3 closed, and an open position permitting it to move outward from the body 13 with which it forms the pocket 4.

When the latch 2 is in the latched position, squeezing the actuating body 1, even when that radically drops the resistance between the conductors 6, does nothing. When, however, the latch 2 has been unlatched, such gripping the door edge and squeezing the body 1 causes the controller 10 to trip the respective operator 11 and unlatch the door, allowing it to be pulled open. Of course in the event of power failure, such a door can be opened manually as described in commonly owned U.S. Pat. No. 5,078,436.

I claim:

1. In a motor-vehicle having a door latch having an electrical operator and displaceable thereby between a latched position holding a respective door shut and an unlatched position permitting the door to open freely, an actuating system comprising:
a deformable actuating body incorporating electrical conductors and constructed to radically change resistance between the conductors when deformed; and
means including a control circuit connected to the conductors and to the electrical latch operator for actuating the operator and displacing the latch in the open position on deformation of the body.

2. The motor-vehicle latch-actuating system defined in claim 1 wherein the body is elongated and formed with a longitudinally extending cavity.

3. The motor-vehicle latch-actuating system defined in claim 2 wherein the body is of an elastically deformable plastic and the conductors are imbedded in and extend longitudinally of the body.

4. The motor-vehicle latch-actuating system defined in claim 3 wherein the conductors are parallel and spaced.

5. The motor-vehicle latch-actuating system defined in claim 1 wherein the control circuit includes a resistance-measuring circuit connected across the conductors.

6. The motor-vehicle latch-actuating system defined in claim 1 wherein the vehicle is formed with a panel having an outwardly directed outer face and an inwardly directed inner face and an edge between the faces, the vehicle further being formed with a pocket at the edge, the body being at the edge on the inner face.

7. The motor-vehicle latch-actuating system defined in claim 1 wherein the latch is displaceable between a locked condition in which the operator is in effective and an unlocked condition in which the operator is effective, the means further comprising
means for displacing the latch into the unlocked position so the body can actuate the operator. condition in which the operator is effective, the means further comprising
means for displacing the latch into the unlocked position so the body can actuate the operator.

8. In a motor-vehicle having an openable door having an edge and an inner face and outer face at the edge, the door being provided with a latch having an electrical operator and displaceable thereby between a latched position holding the door shut and an unlatched position permitting the door to open freely, an actuating system comprising:
a deformable actuating body mounted on the inner face of the door at the edge, incorporating electrical conductors, and constructed to radically change resistance between the conductors when deformed; and
means including a control circuit connected to the conductors and to the electrical latch operator for actuating the operator and displacing the latch in the open position on deformation of the body.

9. The motor-vehicle latch-actuating system defined in claim 8, wherein the vehicle is formed with pocket at the edge behind the body.
